(19) United States
(12) Patent Application Publication
(10) Pub. No.: US 2008/0101836 A1
(43) Pub. Date: May 1, 2008

(54) BOOK BINDING APPARATUS AND IMAGE FORMING APPARATUS HAVING THIS

(75) Inventors: Keiko Fujita, Kashiwa-shi (JP); Kiyoshi Watanabe, Matsudo-shi (JP); Hajime Sekiguchi, Kashiwa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/876,340

(22) Filed: Oct. 22, 2007

(30) Foreign Application Priority Data
Oct. 26, 2006 (JP) 2006-291644
Oct. 15, 2007 (JP) 2007-267563

(51) Int. Cl. G03G 15/00; B42D 1/00

(52) U.S. Cl. 399/390; 281/21.1

(57) ABSTRACT

There is provided a book binding apparatus including: a stacking portion that stacks sheets thereon; and a folding portion that folds the sheets stacked on the stacking portion; wherein there are provided a humidifying portion that humidifies the portion to be made into the folded portion of the sheet before being folded by the folding portion for each sheet to be stacked on the stacking portion.

### BACKGROUND OF THE INVENTION

1. Field of the Invention

The present invention relates to a book binding apparatus for forming a fold line on a booklet and an image forming apparatus having this.

2. Description of the Related Art

Conventionally, a book binding apparatus for folding a sheet outputted from a main body of an image forming apparatus such as a copying machine and a printer folds sheets in two and performs saddle stitching has been known.

The constitution of such a book binding apparatus is disclosed in Japanese Patent Application Laid-Open No. 61-2671. In addition, FIG. 9 shows a schematic block diagram of a main body of a conventional image forming apparatus 10 and a book binding apparatus 11 on their cross sections, which are disclosed in JP-A No. 61-2671.

As shown in FIG. 9, the book binding apparatus 11 is provided with a stack tray 12 as a sheet stacking portion, a folding knife 15 as a folding portion, and a folding roller pair 16 as a fold line forming portion.

On the stack tray 12, an opening portion 14 is disposed on its center portion, and a stopper 13 for stopping the sheet on a fixed position is disposed on an end portion of the stack tray 12. In addition, on the upper part of the opening portion 14 of the stack tray 12, the folding knife 15 is disposed so as to be capable of rising and falling.

When the sheets are conveyed from the main body of the image forming apparatus 10 to the book binding apparatus 11, the conveyed sheets are stacked on the stack tray 12 in series.

Then, the folding knife 15 that is disposed upward of the stack tray 12 falls on the sheets stacked on the stack tray 12, and the folding knife 15 pushes the center portion of the sheet so as to fold the sheet and push the sheet into the opening portion 14 of the stack tray 12.

Then, a plurality of sheets pushed into the opening portion 14 of the stack tray 12 is folded down to be made into a booklet. After that, the booklet is provided to the folding roller pairs 16 being folded down.

The folding roller pairs 16 forms a fold line on the center portion of the booklet by conveying the booklet provided by the folding knife 15 while sandwiching it from the opposite sides.

The booklet having the fold line formed thereon is conveyed on a tray 17 due to rotation of the folding roller pairs 16 to be stacked on the tray 17.

However, even if the conventional book binding apparatus 11 shown in FIG. 9 forms the fold line on the booklet, when a pressure to be added by the folding roller pairs 16 is released, the fold line is opened by an elasticity of the booklet and this makes the booklet into the original condition.

As a result, the fold line cannot be formed on the booklet and this involves a problem such that a visual quality of the booklet is lowered.

Such opening of the fold line remarkably occurs when the sheet with a high rigidity such as a cardboard is used as a sheet forming the booklet and when there are many sheets to form the booklet.

On the other hand, even if the sheet with a low rigidity such as a thin paper is used and there are few sheets forming the booklet, when the rigidity of the sheet in a direction of folding is increased, the fold line is opened. As an example, the case that there is little quantity of water contained in the sheet under a low degree of humidity and the sheet is folded down in a direction perpendicular to a fiber orientation or the like may be considerable.

On the other hand, even if a pressure to be added by the folding roller pairs 16 is increased, the above-described problem is solved only up to a certain degree. Therefore, in order to reliably form the fold line on the booklet, a solving means different from the method to make the pressure of the folding roller pairs 16 larger is obtained.

An example of the solving means is disclosed in JP-A No. 11-157247.

The art disclosed in JP-A No. 11-157247 serves to make it easy to form the fold line on the booklet by humidifying and heating the sheet.

FIG. 10 is a schematic block diagram on a cross section of the book binding apparatus 11 disclosed in JP-A No. 11-157247.

The book binding apparatus 11 shown in FIG. 10 is provided with a humidifying chamber 18 as a humidifying portion, humidifying nozzles 19 and 20, and a heating roller pair 30 as a heating portion.

The humidifying chamber 18 serves to humidify the sheet at an upstream side of the stack tray 12.

In addition, the humidifying nozzle 19 serves to humidify the portion where the fold line is formed at the upstream side of the folding roller pairs 16.

The humidifying nozzle 20 serves to humidify the portion where the fold line is formed at a nip portion of the heating roller pairs 30.

The heating roller pairs 30 serves to form a fold line on the booklet having the portion where the fold line is formed humidified.

If that portion is humidified by the humidifying chamber 18, and the humidifying nozzles 19 and 20, and then, that portion is further heated by the heating roller pairs 30, the rigidity of the portion where the fold line is formed is lowered. Thereby, a folding effect due to the folding roller pairs 16 and the heating roller pairs 30 is increased, so that it is possible to provide a booklet having less opening and a good visual quality.

### SUMMARY OF THE INVENTION

However, since the above-described humidifying chamber 18 is structured so as to humidify the portion where the sheet is not folded down, unnecessary humidification is performed and this is not effective.

In addition, the humidifying nozzles 19 and 20 shown in FIG. 10 only humidify the sheet on the most outside of the booklet, so that it is difficult for the humidifying nozzles 19 and 20 to humidify the sheet on the inside of the booklet. As a result, a humidification amount is varied in the outside of the booklet and in the inside of the booklet, so that the rigidity of the entire booklet cannot be lowered and it is feared that the sufficient fold line is not formed on the booklet so as to lower the quality of the appearance of the booklet.

In addition, the portion that is humidified by the humidifying nozzle 19 is exposed from an opening portion 14 of the stack tray 12 to the outside.

Therefore, water given by the humidifying nozzle 19 evaporates around the area till the booklet is folded down on the inside by the folding roller pairs 16.

As a result, the rigidity of the entire booklet cannot be lowered and it is feared that the sufficient fold line is not formed on the booklet so as to lower the quality of the appearance of the booklet.

In addition, in the case of using the sheet that is particularly hard to absorb water, it is feared that the booklet is curled in a direction that the booklet is opened so as to lower a visual quality of the booklet.

A phenomenon from the sheet is humidified till curling is generated in this way will be described with reference to FIG. 11.

FIG. 11 is a pattern diagram showing a section of a humidified sheet.

A humidifying portion shown in FIG. 11 (namely, a hatched portion in the drawing) is extended once just after being humidified, however, if the sheet is dried again, the humidifying portion shrinks in arrow directions in the drawing.

On the other hand, a no-humidifying portion is hardly effected by humidification and drying, so that this portion does not shrink.

Therefore, a difference in shrinkage amount is caused between the humidifying portion and the no-humidifying portion, so that the sheet is easily curled in a direction that the side of the humidified face shrinks.

On the other hand, as shown in FIG. 11C, when the inside of the fold line formed on the sheet is humidified and the inside of the fold line of the sheet shrinks, the sheet is curled into the inside of the fold line. Therefore, there is no fear that the sheet is opened to the outside of the fold line.

However, as shown in FIG. 11A, the humidifying nozzles 19 and 20 humidify from the outside of the fold line of the booklet, so that the outside of the fold line of the booklet shrinks. Therefore, the sheet is easily curled in a direction that the booklet is opened.

As described above, in order to avoid curling of the sheet into a direction that the booklet is opened, as shown in FIG. 11B, a method for securing a time enough for water given to the sheet that is located at the most outside of the booklet to entirely penetrate in a thickness direction of the sheet may be considered.

However, it is necessary for this method to provide a time that water penetrates through the sheet, so that a production efficiency of the booklet is lowered.

In addition, the conventional heating roller pairs 30 are structured so as to heat the sheet from the outside of the fold line of the booklet. Therefore, water given to the sheet by the humidifying chamber 18 and the humidifying nozzles 19 and 20 moves to the inside of the fold line on the side opposed to the heating side due to a heat from the heating roller pairs 30.

As a result, water remains on the inside of the fold line of the booklet, so that water given to the booklet cannot be removed and further, a crease and a wave are generated on the inside of the fold line of the booklet and it is feared that a quality of the booklet is deteriorated.

Therefore, an object of the present invention is to provide a book binding apparatus that can effectively obtain a booklet with a good appearance without generating unnecessary humidification and shortage of humidification and without lowering a production efficiency of the booklet and an image forming apparatus that is provided with this.

In order to attain the above-described object, the present invention provides a book binding apparatus having: a stacking portion that stacks sheets thereon; and a folding portion that folds the sheets stacked on the stacking portion into a booklet; and a humidifying portion that humidifies a portion of the sheet that is made into a fold line of a booklet before being folded by the folding portion for each sheet to be stacked on the stacking portion.

According to the present invention, it is possible to provide a book binding apparatus that can effectively obtain a booklet with a good appearance without generating unnecessary humidification and shortage of humidification and without lowering a production efficiency of the booklet and an image forming apparatus that is provided with this.

### BRIEF DESCRIPTION OF THE DRAWINGS

The invention, together with further advantages thereof, may best be understood by reference to the following description taken in conjunction with the accompanying drawings in which:

FIG. 1 is a schematic block diagram of an image forming apparatus according to a first embodiment of the present invention;

FIG. 2 is a schematic block diagram of a book binding apparatus according to the first embodiment of the present invention;

FIG. 3 is a control block diagram according to the first embodiment of the present invention;

FIG. 4 is a schematic block diagram of the book binding apparatus according to the first embodiment of the present invention;

FIG. 5 is a schematic block diagram of the book binding apparatus according to the first embodiment of the present invention.

FIG. 6 is a schematic block diagram of a book binding apparatus according to a second embodiment of the present invention;

FIG. 7 is a schematic block diagram of a book binding apparatus according to a third embodiment of the present invention;

FIG. 8 is a schematic block diagram of a book binding apparatus according to a fourth embodiment of the present invention;

FIG. 9 is a schematic block diagram of a conventional book binding apparatus and a conventional image forming apparatus;

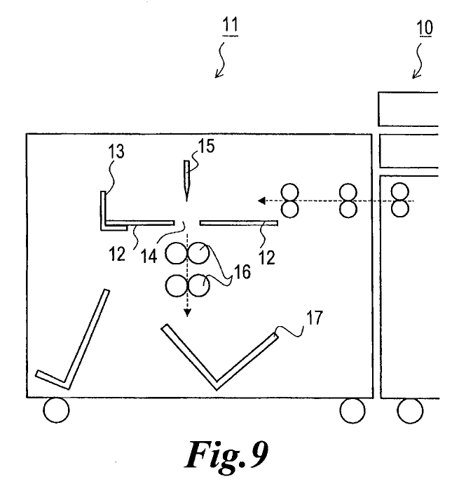

FIG. 10 is a schematic block diagram of the conventional book binding apparatus; and

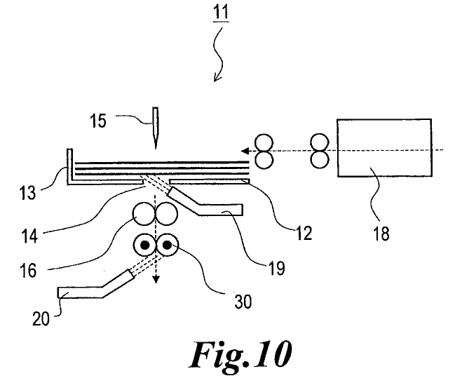

FIGS. 11A to 11C are pattern diagrams for showing generation of curling of a sheet.

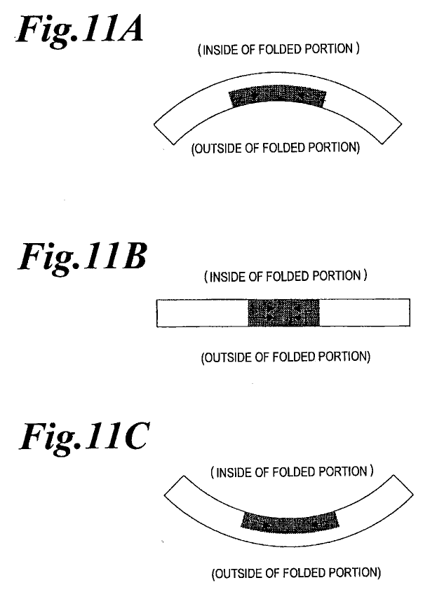

### DESCRIPTION OF THE PREFERRED EMBODIMENTS

Hereinafter, with reference to the drawings, the preferred embodiments of the present invention will be described in detail. However, unless particularly described, a scope of the present invention is not limited to measurements, materials, shapes, and relative positions or the like of components described in these embodiments.

### First Embodiment

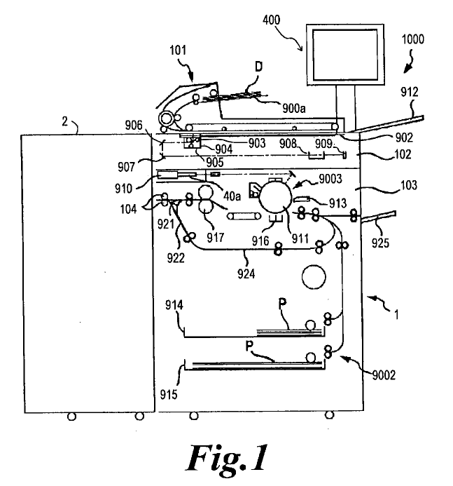

With reference to FIGS. 1 to 5, a book binding apparatus and an image forming apparatus having this according to a first embodiment of the present invention will be described.

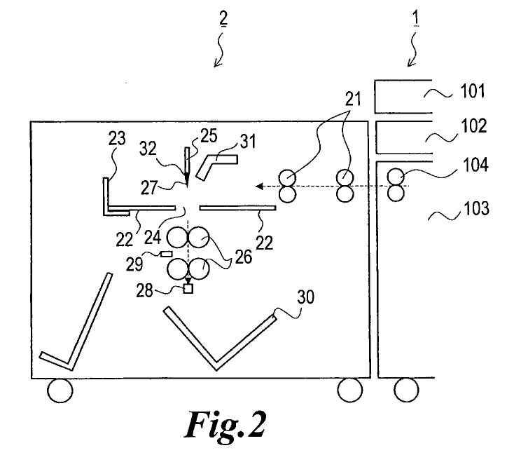

FIG. 1 is a schematic block diagram of a main body of an image forming apparatus 1 on its cross section, and FIG. 2 is a schematic block diagram of a book binding apparatus 2 on its cross section.

As shown in FIG. 1, an image forming apparatus 1000 is provided with an image forming portion 9003 that is disposed in the inside of the main body of the image forming apparatus 1 and a book binding device 2. As an image forming apparatus that is structured in this way, for example, a digital copying machine or the like is considered.

In addition, the main body of the image forming apparatus 1 is provided with a printer portion 103, a scanner 102 that is arranged on the upper face of the printer portion 103, and a document feeding device 101 for feeding a document to the scanner 102.

Further, the scanner 102 for reading an image of the document is provided with a scanner unit 904, mirrors 905 to 907, a lens 908, and an image sensor 909 or the like.

Then, upon reading of a document D by means of this scanner 102, at first, the document D is set on a document tray 900a of the document feeding device 101. In this case, it is assumed that the document D is set in a face-up condition, namely, with the face on which an image is formed on the document tray 900a is on the up.

Next, after conveying the document D one by one from a head page in series by means of the document feeding device 101, the document D is conveyed on a platen glass 902 via a curved path from a left direction into a right direction to be discharged on a discharge tray 912.

Thus, upon reading of the image of the document that has been conveyed by means of the document feeding device 101, reading process of the document D is carried out when the document D passes on the scanner unit 904 from left to right.

Further, specifically, when the document D passes on the platen glass 902, a lamp 903 of the scanner unit 904 irradiates a light to the document D so as to allow the reflection light to attain to the image sensor 909 via the mirrors 905 to 907 and the lens 908.

Then, the image data of the document read by the image sensor 909 for each line is sent to an exposure apparatus 910.

In addition, stopping the document D to be conveyed by the document feeding device 101 on the platen glass 902 once, it is possible to carry out reading process of the document by moving the scanner unit 904 from left to right in this state.

Further, in the case of reading the document without using the document feeding device 101, a user may lift the document feeding device 101 and set the document on the platen glass 902. After that, the user may carry out the reading process of the document.

In addition, the main body of the image forming apparatus 1 is provided with a sheet feeding portion 9002 for feeding a sheet P housed in cassettes 914 and 915 and an image forming portion 9003 for transferring an image on the sheet P that is fed by the sheet feeding portion 9002 other than the above-described devices.

Here, the image forming portion 9003 is provided with a photosensitive drum 911, a development unit 913, and a transfer charger 916 or the like, and upon forming of the image, by irradiating a laser light from the exposure apparatus 910 on the photosensitive drum 911, an electrostatic latent image is formed on the photosensitive drum 911.

Then, this electrostatic latent image is imaged as a toner image by means of the development unit 913. Further, on the downstream side in a conveying direction of the image forming portion 9003, a fixing unit 917 and a discharge roller pair 104 or the like are arranged.

On the upper face of the main body of the image forming apparatus 1, an operation display unit 400 is disposed, and the operation display unit 400 has a plurality of keys for setting various functions for formation of an image and a display unit for displaying the information showing the setting state or the like.

Next, the image forming operation of the main body of the image forming apparatus 1 that is constituted as described above will be described.

At first, as already described, after predetermined imaging process is carried out, the image data of the document D that is read by the image sensor 909 of the scanner 102 is sent to the exposure apparatus 910. After that, the exposure apparatus 910 may output a laser light in response to this image signal.

Then, this laser light is irradiated on the photosensitive drum 911 while being scanned by a polygon mirror. Thereby, on the photosensitive drum 911, an electrostatic latent image in response to the scanned laser light is formed.

Next, the electrostatic latent image formed on the photosensitive drum 911 is developed by the development unit 913 so that the electrostatic latent image is visualized as a toner image.

On the other hand, the sheet P is conveyed from any among the cassettes 914 and 915, a manual sheet feed portion 925, and a double-sided conveyance path 924 to the image forming portion 9003, and on the image forming portion 9003, the visualized toner image on the photosensitive drum 911 is transferred on the sheet P. Then, the transferred sheet P is applied with fixing process by the fixing unit 917.

The sheet P having the image fixed thereon is discharged to a finisher 2 as a book binding apparatus by a discharge roller 104.

For example, in the case of discharging the sheet P from the main body of the image forming apparatus 1 with the face on which the toner image is formed being turned downward (namely, face down), the sheet P passed through the fixing unit 917 is guided to a path 922 by a flapper 921.

Then, going through the flapper 921, the rear end of the sheet P is switched-backed. Then, the sheet P is conveyed to the discharge roller 104 again by means of the flapper 921 to be discharged from the main body of the image forming apparatus 1

Thereby, the sheet P is discharged from the main body of the image forming apparatus 1 with the face where the toner image is formed being in up.

By discharging the sheet P in a face-up condition by such inverted discharge, it is possible to align the page order in the case of carrying out the image forming process in series from a head page of the booklet, namely, in the case of carrying out the image forming process, for example, by using the document feeding device 101.

In addition, also in the case of carrying out the image forming process for the image data from a computer, it is possible to align the page order.

In addition, in the case of carrying out the image forming process while conveying a hard sheet P such as an OHP sheet from the manual sheet feed portion 925, it is not necessary to guide the sheet P to the path 922. In other words, the sheet P may be discharged from the main body of the image forming apparatus 1 by means of the discharge roller 104 with the face where the toner image is formed being in a face-up condition.

Further, in the case of carrying out the image forming process on the opposite sides of the sheet P, the sheet P is guided from the fixing unit 917 straight in a direction of the discharge roller 104.

Then, the sheet P is switch-backed just after the rear end of the sheet P goes through the flapper 921 so as to be guided to the double-sided conveyance path 924 from the path 922 by means of the flapper 921.

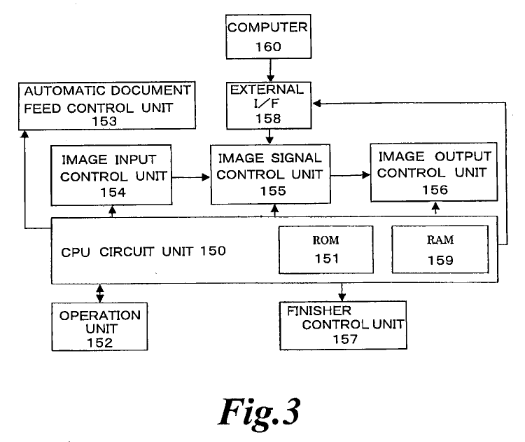

Next, with reference to FIG. 3, a controller of the image forming apparatus 1000 according to the first embodiment will be described. FIG. 3 is a block diagram showing the controller of the image forming apparatus 1000.

As shown in FIG. 3, the controller of the image forming apparatus 1000 is configured by an automatic document feed control portion 153, an image input control unit 154, an image signal control unit 155, an image output control unit 156, a finisher control unit 157, and an external I/F 158. Then, a CPU circuit unit 150 may control these respective control units in accordance with a control program stored in a ROM 151 and setting of an operation unit 152.

Then, the automatic document feed control portion 153 controls the document feeding device 101, the image input control unit 154 controls the scanner 102, the image output control unit 156 controls the exposure apparatus 910, and the finisher control unit 157 controls the book binding apparatus (finisher) 2. In addition, the operation unit 152 has a plurality of keys for setting various functions for formation of the image and the display unit for displaying the setting condition or the like. This operation unit 152 outputs a key signal in response to the operation of each key by means of the user to the CPU circuit unit 150 and displays the information on the display unit on the basis of the signal outputted from the CPU circuit unit 150.

A RAM 159 is used as an area for temporarily holding the control data and an operational area of calculation in accordance with control. The external I/F 158 is an interface with the image forming apparatus 1000 and an external computer 160 and the external I/F 158 extracts the print data from the computer 160 into a bit map image and outputs it to the image signal control unit 155 as the image data.

In addition, the image of the document that is read by an image sensor (not illustrated) from the image input control unit 154 to the image signal control unit 155. The image output control unit 156 outputs the image data from the image signal control unit 155 to an exposure control unit (not illustrated).

Next, with reference to FIG. 2, the constitution of the book binding apparatus 2 according to the first embodiment will be described.

In FIG. 2, the sheet outputted from the main body of the image forming apparatus 1 is conveyed into the book binding apparatus 2 one by one by a conveying roller pair 21 to be stacked on a stack tray 22 as a stacking portion. On the stack tray 22, a stopper 23 is movably arranged on an edge on a downstream side in a sheet conveying direction.

The stopper 23 is positioned in response to the size of the sheet to be used so that a center portion of the sheet to be stacked on the stack tray 22 coincides with the center portion of an opening portion 24 that is formed on the stack tray 22.

Every time each sheet is fed on the stack tray 22, a front end of the sheet hits the stopper 23 by a pulling-over skid (not illustrated) for each sheet and matching of a conveying direction and an orthogonal direction is carried out by a jogging plate (not illustrated).

If all sheets to configure the booklet are stacked on the stack tray 22, a folding knife 25 arranged on the upper part of the opening portion 24 as the folding portion may fall. Then, the folding knife 25 further falls through the opening portion 24 while hitting the center portion of the sheet stacked on the stack tray 22so as to push the sheet downward from the opening portion 24 while folding the center portion of the sheet.

The sheet is folded by the folding knife 25 so that the sheet pushed downward of the stack tray 22 from the opening portion 24 is conveyed as a booklet to the folding roller pairs 26 as a fold line forming portion. Then, the sheet is sandwiched from the opposite sides by the folding roller pairs 26. In this case, a pressure is provided to the booklet so as to form a fold line. Further, the present embodiment may be constituted so that a spring (not illustrated) is connected to the folding roller pairs 26 and the thickness of the booklet may be absorbed.

On the other hand, on the front end portion of the folding knife 25 hitting the center portion of the sheet, a stapler 27 for binding the booklet by a stopper (a needle of the stapler) is disposed. Further, down below the folding roller pairs 26, a strike plate 28 of the stapler that can move for the sheet conveying path is disposed.

In other words, the book binding apparatus 2 according to the first embodiment is configured so as to be capable of carrying out the saddle stitching process by means of the stapler 27 and the strike plate 28 while carrying out the folding process for the booklet by means of the folding roller pairs 26.

After the folding process and the saddle stitching process are carried out, the folding knife 25 leaves from a nip position of the folding roller pairs 26 while rising. Then, by further rotating the folding roller pairs 26, the booklet having the fold line formed is conveyed in a direction of a tray 30.

Further, in the book binding apparatus 2 shown in FIG. 2, the stack tray 22 is described as a constitution that is horizontally arranged. However, the constitution of the book binding apparatus 2 is not limited to this and if the book binding apparatus 2 is configured at an angle in the range of 0° to 85° for a horizontal face, the sheet can be stacked on the stack tray 22.

In addition, the stapler 27 is described as the constitution that is integrally disposed on the front end portion of the folding knife 25, however, the constitution of the book binding apparatus 2 is not limited to this.

For example, the stapler 27 as a different body from the folding knife 25 may be disposed on the upstream side of the folding knife 25 together with the strike plate 28. In this constitution, due to the operation of the stopper 23 and the pulling-over skid (not illustrated), two stopping positions of the sheet on the stack tray 22 are provided, and the saddle stitching process is carried out on the stack tray 22 in first, so that the folding process can be carried out.

These controls for the sheet are carried out from the CPU circuit unit 150 on the side of the main body of the image forming apparatus 1 via the finisher control unit 157 on the side of the book binding apparatus 2 on the basis of setting of various process modes that are inputted from the operation unit 152 or the external computer 160. However, disposing the finisher control unit 157 so as to be integrated with the CPU circuit unit 150 on the side of the main body of the image forming apparatus 1, the sheet may be controlled directly from the main body of the image forming apparatus 1.

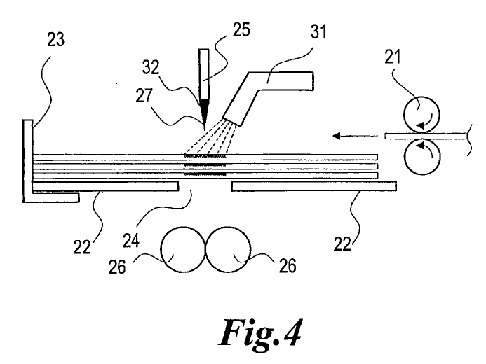

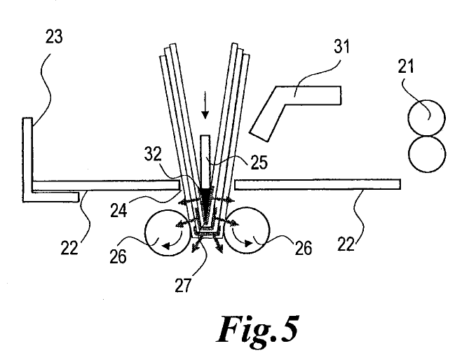

Next, with reference to FIG. 4 and FIG. 5, the constitution of the humidifying portion according to the first embodiment of the present invention will be described.

As shown in FIG. 4 and FIG. 5, on the book binding apparatus 2 according to the first embodiment, a humidifying nozzle 31 as the humidifying portion is arranged on the upper part of the opening portion 24 of the stack tray 22.

The humidifying nozzle 31 may supply water to the portion forming the fold line of the booklet of the sheet that is conveyed on the stack tray 22. As a result, the rigidity of the sheet can be lowered, so that a folding effect due to the folding roller pairs 26 is increased and it is possible to obtain the sheet having a small opening and a good appearance. This constitution is efficient because humidification is not made on a portion that there is no need for folding and humidification can be made only on a necessary portion.

In addition, the humidifying nozzle 31 of the book binding apparatus 2 according to the first embodiment of the present invention is constituted so as to humidify the stacked sheet from the side that becomes the inside of the booklet after the folding process. When humidification is made on the portion that becomes the inside of the booklet before the folding process, this portion is extended once.

However, in the process that the inside of the booklet after the folding process, a force in a direction that the portion shrinks more than the shape before humidification is generated. As a result, the inside of the booklet is contracted than the original shape and the shape of the outside of the booklet having no effect of humidification and drying is not changed.

Thereby, the booklet is curled in a folding direction and the curling in a direction that the booklet is opened can be prevented. This makes it possible to provide a booklet with a good appearance.

In addition, the humidifying nozzle 31 of the book binding apparatus 2 according to the first embodiment of the present invention is structured so as to humidify the booklet from the upper part of the stack tray 22.

Thereby, it is possible to humidify the sheet to be stacked on the stack tray 22 one by one. As a result, humidification is not biased within the booklet and the rigidity of the booklet can be sufficiently decreased.

Further, by controlling the humidification amount for each sheet, a large amount of humidification can be given to the inside of the booklet rather than the outside of the booklet, so that it is possible to reliably obtain an advantage of prevention of curling above. As described above, the humidification control is carried out by communication between the CPU circuit unit 150 located on the side of the main body of the image forming apparatus 1 and the finisher control unit 157 located on the side of the book binding apparatus 2.

In addition, the stacking portion of the book binding apparatus 2 according to the first embodiment of the present invention is constituted so as to load the sheet on the face where the sheet is humidified in series. Thereby, the humidifying portion of the stacked sheet is covered with the sheet to be stacked from above of that sheet and this leads to that there is no fear that the humidifying portion of the sheet is exposed around the area.

As a result, till the booklet is applied with the folding process by means of the folding roller pairs 26, it is possible to prevent water given to the sheet from evaporating around the area, so that the humidifying state can be kept well.

In addition, the stacking portion of the book binding apparatus 2 according to the first embodiment of the present invention is constituted in such a manner that the sheet to be stacked on the stack tray 22 at first is located at the most outside of the booklet and on the other hand, the sheet to be stacked at last is located at the most inside of the booklet.

Thereby, the sheet that is stacked and humidified at first can secure a sufficient time that water given by the humidifying portion entirely penetrates in a direction of a thickness of the sheet till the sheet to be stacked at last is humidified.

In other words, since a time for making water entirely penetrate in a direction of a thickness of the sheet is not necessarily secured separately in the process of binding, it is possible to provide a booklet with better appearance of the booklet without lowering a production efficiency of the booklet of the book binding apparatus 2.

Further, as the humidifying nozzle 31 according to the first embodiment of the present invention, one for injecting a liquid drop by a piezoelectric device and one for injecting a liquid drip by air bubbles generated due to heat, which are used for a head of an inkjet printer, can be applied. In addition, the fixed humidifying nozzle 31 may be disposed across the entire area where the fold line is formed or the fixed humidifying nozzle 31 may be disposed, which scans the portion where the fold line is formed in a direction along an inner-folded line.

In addition, the humidifying portion according to the first embodiment of the present invention is not limited to the humidifying nozzle 31 but it is obvious that the same advantage can be obtained even by the constitution to apply water by a roller and a brush or the like.

In addition, as a humidifying solution, a liquid that does not temporarily decrease the rigidity of the sheet when forming a fold line and the booklet evaporates after forming a fold line to be dried after the fold line is formed so as not to block the appearance of the booklet, for example, a volatile component such as water and ethanol and a transparent ink for an inkjet printer or the like may be available.

Further, the temperature of the humidifying solution is not limited to a room temperature and the humidifying solution may be a heated moisture vapor or the like. In this case, it is obvious that the rigidity of the sheet is rapidly lowered due to heat and water, the folding advantage by means of the folding roller pairs 26 is enhanced, and the booklet with a good appearance having a small opening can be provided.

Next, with reference to FIG. 4 and FIG. 5, the constitution of the heating portion according to the first embodiment of the present invention will be described.

As shown in FIG. 4 and FIG. 5, in the book binding apparatus 2 according to the first embodiment of the present invention, a heating front end 32 as a heating portion is disposed on the front end portion of the folding knife 25.

The heating front end 32 enables to lower the rigidity of the booklet by supplying heat to the portion where the fold line is formed. As a result, the folding advantage due to the folding roller pairs 26 is increased and the booklet with a good appearance having a small opening can be obtained.

In addition, the heating front end 32 also enables to efficiently discharge unnecessary water from the booklet having a fold line formed by the folding roller pairs 26. Further, as shown in FIG. 5, when the folding roller pairs 26 adds a pressure to the portion where the fold line is formed, if the heating front end 32 supplies heat to the portion where the fold line is formed, the fold line can be reliably given.

According to this constitution, by sandwiching the booklet including the heating front end 32, the fold line can be formed while heating the fold line.

In addition, the heating front end 32 is configured so as to heat the fold line from the inside of the fold line of the booklet. Therefore, as shown by an arrow of FIG. 5, water given to the booklet moves from the heating side toward the outside of the booklet.

Therefore, by heating the sheet of the inside having a short time that water entirely penetrates in a direction of a thickness of the sheet after being given humidification as described above by means of the heating front end 32, it is possible to move water rapidly from the inside toward the outside of the sheet.

As a result, without lowering a production efficiency of the booklet, water entirely penetrates in a direction of a thickness of the sheet and curling generated when the booklet is dried can be decreased.

In addition, unnecessary water is discharged from the outside of the booklet around the area without accumulation. Therefore, a crease and a wave due to water accumulated inside of the booklet are not generated, so that unnecessary water inside of the booklet can be reliably and efficiently removed.

In addition, since the heating front end 32 is integrally formed with the folding knife 25, the heating front end 32 can efficiently give heat with a high degree of accuracy to the portion where the fold line is formed.

In addition, since the heating front end 32 is configured so as to give heat to the portion where the fold line is formed in synchronization with the folding operation of the booklet by means of the folding knife 25, the heating front end 32 can efficiently give heat.

As the heating portion of the book binding apparatus 2 according to the first embodiment of the present invention, for example, an external heating unit having a heat source outside, an internal heating unit having a heat source inside, and unit for generating heat on the heating front end 32 itself by electromagnetic induction heating or the like can be applied. In addition, if a heating temperature is about 100° C. or higher, it is possible to efficiently promote to discharge water in the booklet while preventing curling of the booklet.

### Second Embodiment

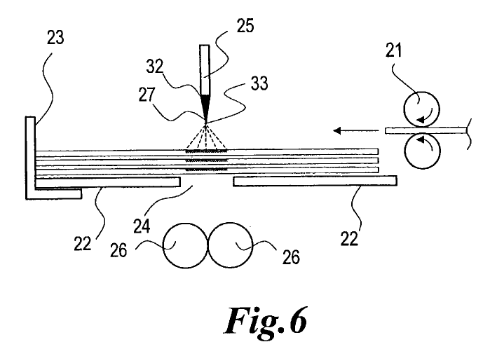

Hereinafter, with reference to FIG. 6, a second embodiment of the present invention will be described.

However, since the constitution and the operation of the main body of the image forming apparatus 1, the constitutions of the stacking portion of the book binding apparatus 2 and the fold line forming portion are not different from the first embodiment, the explanations thereof will not be described herein. Here, the constitutions of the folding portion, the heating portion, and the humidifying portion will be described, which are characteristics of the second embodiment.

According to the first embodiment, the humidifying nozzle 31 as the humidifying portion is disposed independently from the folding knife 25 forming the folding portion. However, the humidifying portion of the book binding apparatus 2 is not limited to this.

According to the second embodiment, as shown in FIG. 6, a humidifying nozzle 33 is integrally disposed on the front end portion of the folding knife 25. From even such a constitution, the same advantage as the first embodiment can be obtained.

According to the second embodiment, without necessity to dispose the humidifying nozzle 33 separately, the folding knife 25 and the humidifying nozzle 33 can be integrated, so that a space can be saved. In addition, by integrally forming the humidifying nozzle 33 and the folding knife 25, it is possible to efficiently humidify the portion where the fold line is formed with a high degree of accuracy.

Further, according to this constitution, by using heat of the heating front end 32, it is possible to inject the heated heating solution. Therefore, the rigidity of the portion where the fold line is formed can be lowered more efficiently. Thereby, it is possible to provide a booklet with a good appearance having a small opening.

### Third Embodiment

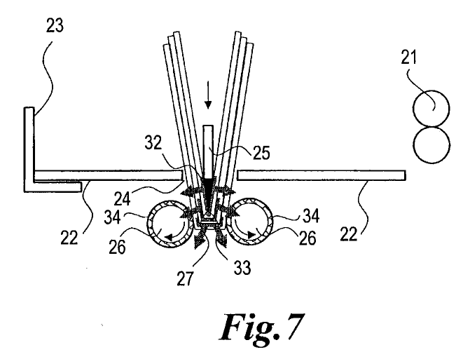

Hereinafter, with reference to FIG. 7, a third embodiment according to the present invention will be described.

However, since the constitution and the operation of the main body of the image forming apparatus 1, the constitutions of the stacking portion of the book binding apparatus 2, the fold line forming portion, and the heating portion or the like are not different from the first embodiment, the explanations thereof will not be described herein.

Here, the constitutions of the fold line folding portion and a dehumidifying portion will be described, which are characteristics of the third embodiment. In addition, in the humidifying portion according to the third embodiment, like the first embodiment, the humidifying portion may be disposed on the upper part of the stack tray 22 or like the second embodiment, the humidifying portion may be disposed integrally with the folding knife 25 to configure the folding portion.

As shown in FIG. 7, according to the third embodiment, in addition to the first embodiment, the dehumidifying portion for dehumidifying the portion where the fold line is formed from the outside of the fold line is disposed. Further, the dehumidifying portion is configured so that an absorption body 34 is integrally disposed on the outer peripheral face of the folding roller pairs 26 as the fold line forming portion.

In such a constitution, when forming the fold line on the booklet, the absorption body 34 and the heating front end 32 are disposed on the opposed position via the booklet. When the heating front end 32 gives heat to the booklet, water given to the inside of the fold line of the booklet by the humidifying portion moves from the heating front end 32 to the outside of the fold line.

Then, water moved to the outside of the fold line is rapidly absorbed by the absorption body 34. Thereby, it is possible to discharge unnecessary water from the booklet after the fold line is formed thereon more efficiently and remove it more reliably.

In addition, since the absorption body 34 is disposed on the outer peripheral face of the folding roller pairs 26, it is possible to efficiently dehumidify with good timing from the booklet having the fold line formed in synchronization with the operation for forming the fold line of the booklet by means of the folding roller pairs 26.

Further, it is preferable that the absorption body 34 according to the present invention uses a material with good water-absorbing property, for example, a foam body, a porous body, and a fabric absorption body.

### Fourth Embodiment

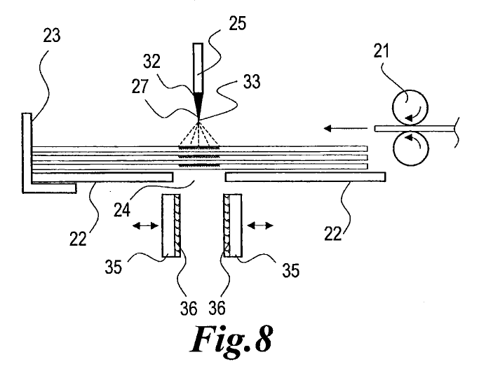

Hereinafter, with reference to FIG. 8, a fourth embodiment according to the present invention will be described.

However, since the constitution and the operation of the main body of the image forming apparatus 1, the constitutions of the stacking portion of the book binding apparatus 2, the folding portion, and the heating portion or the like are not different from the first embodiment, the explanations thereof will not be described herein. Here, the constitutions of the fold line forming portion and the dehumidifying portion will be described, which are characteristics of the forth embodiment. In addition, in the humidifying portion according to the fourth embodiment, like the first embodiment, the humidifying portion may be disposed on the upper part of the stack tray 22 or like the second embodiment, the humidifying portion may be disposed integrally with the folding knife 25 to configure the folding portion.

According to the third embodiment, the fold line forming portion and the dehumidifying portion are configured by the folding roller pairs, however, the constitutions of the fold line forming portion and the dehumidifying portion are not limited to this.

According to the fourth embodiment, as shown in FIG. 8, the fold line forming portion is configured by at least a pair of press plates 35 compose of a pair of plate members and an absorption body 36 as the dehumidifying portion is disposed on the surface contacting the booklet of the press plate 35.

Due to such a constitution, the area where the absorption body 36 contacts the sheet can be made larger, so that it is possible to further prompt the dehumidification advantage for the booklet.

Thereby, it is possible to provide a book binding apparatus which can obtain a booklet with a good appearance without generating unnecessary humidification or shortage of humidification and an image forming apparatus having this.

According to the above-described embodiments, although the constitution that the folding portion and the fold line forming portion are provided separately is described as an example, the constitution that the folding portion and the fold line forming portion cannot be separated in a function that the both of them apply the folding process to the sheet so as to obtain a booklet as a deliverable. Particularly, when the folding knife is configured so as to enter the nip portion of the folding roller pairs and transfers the sheet, there is no inconvenience when the folding knife and the folding roller pairs are referred to as a folding portion as an integrate part. However, by employing the constitution according to the present invention, the sufficient fold line can be formed only by the folding knife and the booklet with a good appearance having a small opening can be obtained, so that the folding roller pairs may be omitted.

This application claims priority from Japanese Patent Application No. 2006-291644 filed Oct. 26, 2006, and Japanese Patent Application No. 2007-267563 filed Oct. 15, 2007, which are hereby incorporated by reference, herein.

What is claimed is:

1. A book binding apparatus comprising:
a stacking portion that stacks sheets thereon;
a folding portion that folds the sheets stacked on the stacking portion into a booklet; and
a humidifying portion that humidifies a portion of the sheet that is made into a fold line of the booklet before being folded by the folding portion for each sheet to be stacked on the stacking portion.

2. A book binding apparatus according to claim 1,
wherein the humidifying portion humidifies the portion of the sheet from the side that becomes the inside of the booklet.

3. A book binding apparatus according to claim 2,
wherein the sheets are stacked in series on the face side of the sheet that is humidified by the humidifying portion.

4. A book binding apparatus according to claim 1,
wherein the humidifying portion humidifies the portion of the sheet that is made into the fold line of the booklet from the sheet that is made into the outside of the booklet in series.

5. A book binding apparatus according to claim 1,
wherein the folding portion has a front end portion that pushes the sheet; and
the humidifying portion is integrally provided with the folding portion on the front end portion of the folding portion.

6. A book binding apparatus according to claim 1, further comprising:
a heating portion that heats the portion of the sheet that is made into the fold line of the booklet from the inside of the booklet folded by the folding portion.

7. A book binding apparatus according to claim 6,
wherein the folding portion has a front end portion that pushes the sheet; and
the heating portion is integrally provided with the folding portion on the front end portion of the folding portion.

8. A book binding apparatus according to claim 1, having a fold line forming portion that forms a fold line on a booklet made of sheets folded by the folding portion;
wherein the fold line forming portion comprises at least a pair of roller members.

9. A book binding apparatus according to claim 1, having a fold line forming portion that forms a fold line on a booklet made of sheets folded by the folding portion;
wherein the fold line forming portion comprises at least a pair of plate members.

10. A book binding apparatus according to claim 1, comprising a dehumidifying portion that dehumidifies a portion where a fold line of a booklet is formed.

11. A book binding apparatus according to claim 6, comprising a dehumidifying portion that dehumidifies a portion where a fold line of a booklet is formed, wherein the dehumidifying portion is disposed on a position opposed to the heating portion via the booklet when forming the fold line of the booklet.

12. A book binding apparatus according to claim 10,
wherein the dehumidifying portion is integrally provided with the fold line forming portion.

13. An image forming apparatus comprising:
an image forming portion that forms an image on a sheet; and
the book binding apparatus according to claim 1 that binds the sheets of which image are formed by the image forming portion.
